(19) United States
(12) Patent Application Publication
(10) Pub. No.: US 2008/0184354 A1
(43) Pub. Date: Jul. 31, 2008

(54) SINGLE SIGN-ON SYSTEM, INFORMATION TERMINAL DEVICE, SINGLE SIGN-ON SERVER, SINGLE SIGN-ON UTILIZATION METHOD, STORAGE MEDIUM, AND DATA SIGNAL

(75) Inventor: Makoto Yamazaki, Kanagawa (JP)

Correspondence Address: GAUTHIER & CONNORS, LLP, 225 FRANKLIN STREET, SUITE 2300, BOSTON, MA, 02110, US

(73) Assignee: FUJI XEROX CO., LTD., Tokyo (JP)

(21) Appl. No.: 11/839,122

(22) Filed: Aug. 15, 2007

(30) Foreign Application Priority Data
Jan. 25, 2007 (JP) 2007015583

(51) Int. Cl. G06F 7/04

(52) U.S. Cl. 726/8

(57) ABSTRACT

There is provided a single sign-on server including a receiving unit that receives a server connection request which is transmitted from a client for a service provision server that provides a service; an establishing unit that transmits, to a service provision server identified from the received server connection request, an authentication request that contains at least an address for use in communication with the service provision server and authentication information set for the single sign-on server, undergoes user authentication, and establishes a session with the service provision server; a disabling unit that performs disabling processing of the address which is being used in communication with the service provision server; and an information transmission unit that transmits session information on the session established with the service provision server, the session information containing at least the address, to the client that transmits the server connection request.

### CROSS-REFERENCE TO RELATED APPLICATIONS

This application is based on, and claims priority under 35 USC 119 from, Japanese Patent Application No. 2007-015583 filed Jan. 25, 2007.

### BACKGROUND

1. Technical Field

The present invention relates to a single sign-on system, an information terminal device, a single sign-on server, a single sign-on utilization method, a storage medium and data signal.

2. Related Art

Today, various computers and/or applications often require prior input of a user ID and a password for the purpose of security maintenance when users utilize them. For example, a user of a terminal connected to a network can be required to input a user ID and a password a number of times, such as when the user starts up the terminal, connects it to the network, connects it to a server, and/or activates an application on the server. A system called single sign-on has emerged as a function that can free a user from such input of all user IDs and passwords once the user is authenticated. Single sign-on means that a user is allowed to utilize every function which the user is authorized to use just by getting authenticated once. That is, when single sign-on is adopted, the user only has to undergo a single authentication even when they receive a service from a server that provides services by executing applications.

### SUMMARY

According to an aspect of the present invention, there is provided a single sign-on system including service provision servers that provide services, a client that utilizes a service provided by the service provision servers, and a single sign-on server that realizes single sign-on, wherein the single sign-on server includes: a receiving unit that receives a server connection request transmitted from the client; an establishing unit that transmits, to a service provision server identified from the received server connection request, an authentication request that contains at least an address for use in communication with the service provision server and authentication information of the single sign-on server, undergoes user authentication, and establishes a session with the service provision server; a disabling unit that performs disabling processing of the address which is being used in communication with the service provision server; and an information transmission unit that transmits session information on the session established with the service provision server, the session information containing at least the address, to the client that transmits the server connection request, and wherein the client includes: a request transmission unit that transmits to the single sign-on server a server connection request for the service provision server; a session information receiving unit that receives session information transmitted from the single sign-on server in response to the transmitted server connection request; and a communication unit that uses an address contained in the session information received by the information receiving unit for communication with the service provision server, and takes over the session that has been established by the single sign-on server with the service provision server to communicate with the service provision server.

### BRIEF DESCRIPTION OF THE DRAWINGS

Exemplary embodiment the present invention will be described in detail based on the following figures, wherein:

FIG. 1 shows the general configuration of a single sign-on system according to an exemplary embodiment;

FIG. 2 shows the hardware configuration of each of the computers constituting a server, a client, and an SSO server in this exemplary embodiment;

FIG. 3 is a block diagram showing the configuration of the single sign-on system according to this exemplary embodiment;

FIG. 4 is a flowchart showing the operation procedure of the client in this exemplary embodiment;

FIG. 5 is a flowchart showing the operation procedure of the SSO server in this exemplary embodiment; and

FIG. 6 shows an exemplary data configuration of an address pool which is referenced by an address decision unit in this exemplary embodiment.

### DETAILED DESCRIPTION

An exemplary embodiment of the invention will be described with respect to drawings.

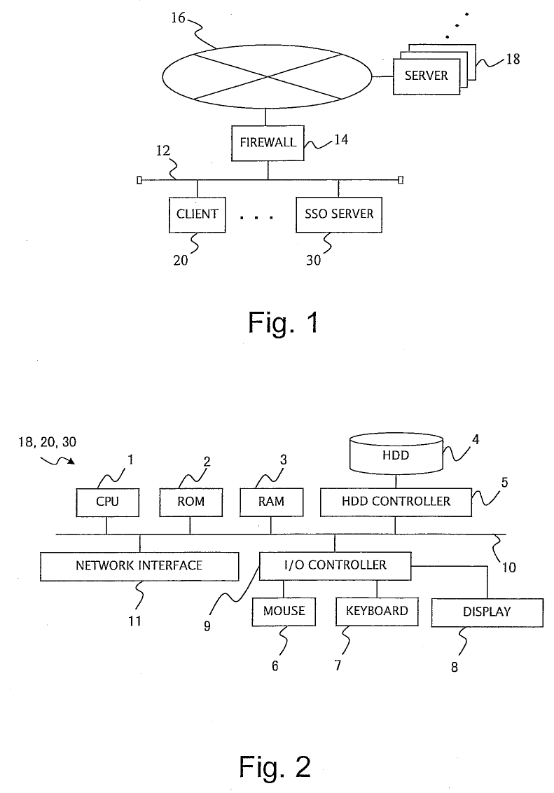

FIG. 1 shows the general configuration of a single sign-on system according to this exemplary embodiment. FIG. 1 illustrates servers 18, a client 20, and a single sign-on (SSO) server 30. The servers 18 are server computers that provide services by executing a predetermined application on demand. The client 20 is a client computer used by a user who wants to utilize a service provided by the servers 18. The SSO server 30 is a server computer that realizes single sign-on. The client 20 and the SSO server 30 are connected to the same LAN 12, and perform data communication with the server 18 via a firewall 14 and a public network 16.

FIG. 2 shows the hardware configuration of each of the computers constituting the server 18, client 20 and SSO server 30 of this exemplary embodiment. As shown in FIG. 2, the computer is structured by connecting, to an internal bus 10, a CPU 1, ROM 2, RAM 3, an HDD controller 5 to which a hard disk drive (HDD) 4 is connected, an input/output controller 9 to which a mouse 6 and a keyboard 7, which are provided as input means, and a display 8, which is provided as a display device, are connected, and a network interface 11 provided as communication means. Although the computers constituting the server 18, the client 20 and the SSO server 30 may have differences in functionality, they can be illustrated as FIG. 2 because their hardware can be realized with a conventional and generic hardware configuration.

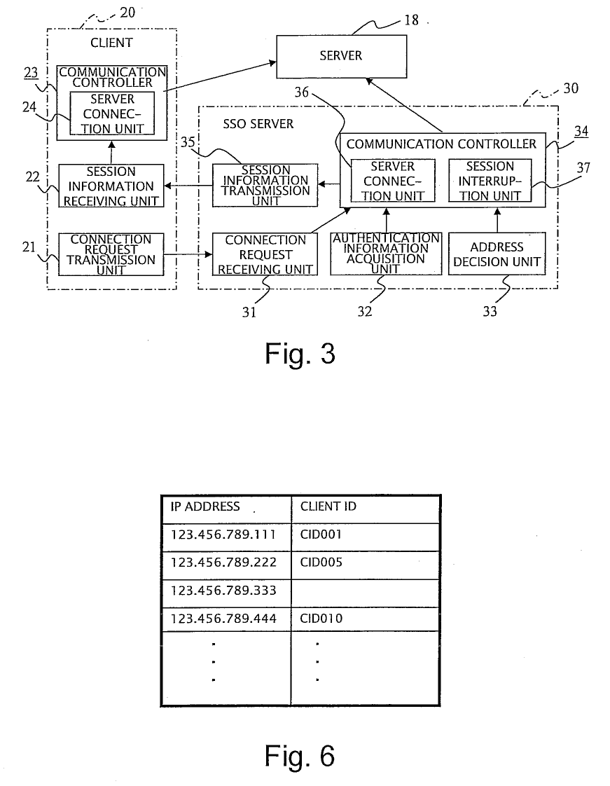

FIG. 3 is a block diagram showing the configuration of the single sign-on system according to this exemplary embodiment. As the servers 18 and the clients 20 have to respectively include similar functions, only one server 18 and one client 20 are shown in FIG. 3. The server 18 requires no additional function that should be newly added for realization of this exemplary embodiment and can be realized only with existing functions. Accordingly, functional blocks that are utilized for practicing this exemplary embodiment, such as user authentication function, are omitted in FIG. 3.

The client 20 includes a connection request transmission unit 21, a session information receiving unit 22, and a communication controller 23. The connection request transmission unit 21 transmits to the SSO server 30 a connection request for a desired server 18. The session information receiving unit 22 receives session information which is sent from the SSO server 30 in response to the transmitted connection request. The communication controller 23 controls data communication performed with the server 18. A server connection unit 24 included in the communication controller 23 sets an IP address contained in session information received by the session information receiving unit 22 in a network interface 11 to thereby use the IP address in the communication with the server 18 specified by the connection request.

The components 21 through 23 of the client 20 are realized by cooperative operation of a computer that constitutes the client 20 and a program running on the CPU 1 contained in the computer.

The SSO server 30 includes a connection request receiving unit 31, an authentication information acquisition unit 32, an address decision unit 33, a communication controller 34, and a session information transmission unit 35. The connection request receiving unit 31 receives a connection request transmitted from the client 20. The authentication information acquisition unit 32 acquires authentication information necessary for getting authenticated by the server 18 specified by the connection request, in this exemplary embodiment, authentication information used for the SSO server 30 to get authenticated by the server 18. The address decision unit 33 decides an IP address for use in communication with the server 18. The communication controller 34 controls data communication performed with the server 18. A server connection unit 24 included in the communication controller 34 sets an IP address decided by the address decision unit 33 in the network interface 11, and also establishes a session with the server 18, such as by sending an authentication request, to enable data communication. A session interruption unit 37 performs disabling processing for stopping the use of a session established with the server 18, such as deleting the IP address which is being used for communication with the server 18 from the network interface 11. After the IP address is disabled through the execution of disabling processing by the session interruption unit 37, the session information transmission unit 35 transmits session information on the session that was established with the server to the client 20 which transmitted the connection request.

The components 31 through 35 of the SSO server 30 are realized by cooperative operation of a computer that constitutes the SSO server 30 and a program which, unless otherwise noted, runs in the CPU 1 contained in the computer.

The program used in the exemplary embodiment mentioned above can be provided by communication means, of course, or can also be provided being stored on a recording medium such as a CD-ROM.

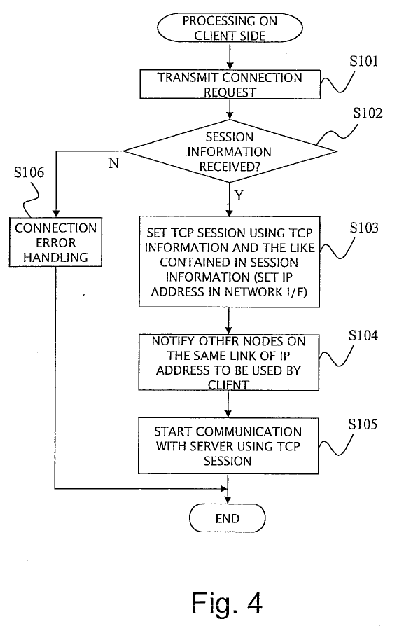

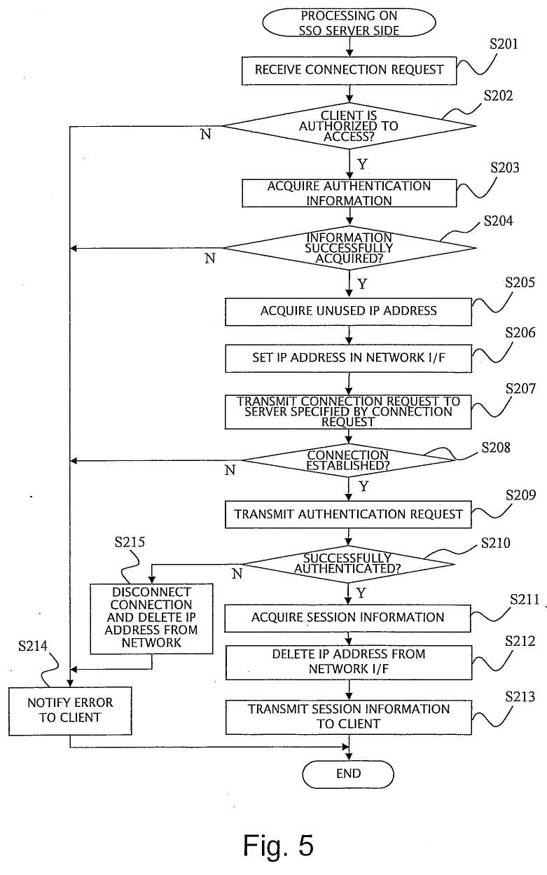

The client 20 will establish a session with a desired server 18 to receive a service provided by that server 18. Next, with reference to the flowcharts shown in FIGS. 4 and 5, description will be given of operations performed in this exemplary embodiment from when the client 20 requests a connection with a desired server 18 to when a session is established therebetween to enable the client 20 to receive the service.

First, when the user of the client 20 who wants to utilize a service provided by a desired server 18 performs a predetermined user operation, the connection request transmission unit 21 transmits to the SSO server 30 a connection request for the server 18 (step 101). Information representing the connection request includes client authentication information and server connection information. The client authentication information is authentication information for causing the SSO server 30 check that the client 20 of interest is authorized to connect to the SSO server 30, including the identification information (hereinafter a “client ID”) for the client 20 and a password. Although this exemplary embodiment uses an IP address as the client ID, the client ID is not limited to an IP address and can be any information that can identify the client 20, such as a MAC address. As will be described in more detail below, the client 20 will receive session information including an IP address from the SSO server 30. By including an IP address in client authentication information, the IP address can be used not only as a client ID but as destination information for session information on the SSO server 30.

The server connection information includes information necessary for establishing communication with the server 18. Specifically, it includes at least information that can identify the server 18 as the target of connection, such as the name or IP address of the server 18. If information such as a port number and a protocol are included together, a client 20 that can adopt various communication schemes can be flexibly supported.

On the SSO server 30, upon receipt of the connection request sent from the client 20 (step 201), the connection request receiving unit 31 references client authentication information contained in the connection request to check in advance whether the client 20 is authorized or not. That is, the SSO server 30 does not meet a request from every client 20, but limits clients 20 that can utilize this exemplary embodiment. Accordingly, the connection request receiving unit 31 performs user authentication with a client ID and a password contained in the connection request, and if the authentication shows that the client 20 is authorized (Y at step 202), it passes server connection information to the communication controller 34. However, if the client 20 is not authorized (N at step 202), the SSO server 30 notifies the client 20, which is the sender of the connection request, of an error to the effect that the client 20 cannot be authenticated (step 214).

Upon receiving a notification that the client 20 has been authenticated by the connection request receiving unit 31, the authentication information acquisition unit 32 acquires authentication information necessary for the SSO server 30 to establish a connection with the server 18 which is specified by the connection request (step 203). The authentication information acquired here is authentication information (a user ID and a password) of the SSO server 30 which has been obtained in advance by the SSO server 30 in order to access the server 18. That is, the authentication information acquisition unit 32 obtains authentication information necessary for connecting to a server 18 specified by the connection request from among items of authentication information which are necessary for accessing the servers 18 and correspond to each of the servers 18. Accordingly, server connection information needs to be contained in the notification received from the connection request receiving unit 31. A directory database in which authentication information for each server 18 is accumulated may be stored in the HDD 4 of the SSO server 30, or maintained and managed in an external device: the authentication information acquisition unit 32 retrieves necessary authentication information from a known storage. If the authentication information acquisition unit 32 has normally acquired authentication information (Y at step 204), it passes the acquired authentication information to the communication controller 34. On the other hand, if the authentication information acquisition unit 32 failed to acquire authentication information for such reasons as an error in specification of the server 18 on the client 20, or the server 18 not being covered by the SSO server 30 (N at step 204), the SSO server 30 notifies the client 20 which sent the connection request of an error to the effect that authentication cannot not be made with the server 18 (step 214).

Then, the address decision unit 33 acquires an IP address for use in communication with the server 18 specified by the connection request (step 205). The IP address acquired by the address decision unit 33 is at least one IP address which has been secured on the SSO server 30 or in the system for use in communication with the server 18, and this exemplary embodiment manages such secured IP addresses in an address pool.

FIG. 6 shows an exemplary data configuration of the address pool used in this exemplary embodiment. In the address pool, an IP address secured in advance and a client ID are managed in association with each other, and an IP address which is being used is associated with the client ID of the client 20 which is using that IP address. Accordingly, an IP address having a blank client ID field can be determined to be an unused address, so that the address decision unit 33 takes one IP address having a blank client ID field from the address pool, and decides the address as an IP address for use in communication with the server 18 specified by the connection request. When there are a number of unused IP addresses, the address decision unit 33 may decide one IP address according to a predetermined rule, e.g., to use one at a higher position in the address pool.

The data configuration of the address pool shown in FIG. 6 is just an example. Thus, the data configuration may be such that an IP address is associated with flag information indicating whether the IP address is in use or not, or with identification information for the SSO sever 30 which has acquired that IP address. Also, use of the address pool is not essential: an unused IP address may be selected from among arbitrary IP addresses which are available on the same link and decided as an IP address for use in communication with the server 18 specified by a connection request, instead of using an address pool. More specifically, an arbitrary IP address that is available is selected, and an inquiry is made as to whether or not the IP address is already used. For example, an Address Resolution Protocol (ARP) command is used to check the MAC address of a node which possesses that IP address. If there is no response to the command, the IP address proves to be an unused address, so that it is decided as the IP address for use in communication with the server 18. On the other hand, if there is a response to the command, which means that the IP address is already used, another IP address is selected and similar processing is repeated. If all the possible IP addresses are in use, predetermined error handling is performed to terminate the process. The processing of a search for an unused IP address may be repeated a predetermined number of times or may be performed for a certain time period, and the number of times or duration of a search processing may be dynamically varied in accordance with the importance of the server 18 specified by the connection request or the importance (or priority) of the connection request. After an unused IP is found and decided as an IP address for use in communication with the server 18, other nodes may be notified that the IP address is going to be used. This is to prevent prior use of the IP address by another node. Search for an unused address can employ an arbitrary algorithm. For example, a known method for detecting overlapping addresses which is known as Duplicate Address Detection (“DAD”) may be used. In this exemplary embodiment, an “unused address” includes an IP address that has never been used as well as an IP address that has been used once but is not currently used. In short, the IP address only has to be unused at least for an expected or anticipated time period for which it will be used in communication with the server 18.

This exemplary embodiment can be practiced when there is at least one unused IP address. However, because data communication cannot be performed in parallel between the server 18 and the client 20 with only one IP address, this exemplary embodiment secures a number of IP address in advance and manages them in an address pool so that an unused IP address can be selected from the pool. The address pool may be stored in the RAM 3 or the HDD 4 of the SSO server 30, or may be arranged to be maintained and managed in an external device. If a number of SSO servers 30 are provided in the system, the address pool is advantageously maintained and managed in an external device. The address decision unit 33 takes an IP address to be used this time from a known storage.

It is possible to process the steps 203 and 204 in parallel with step 205.

Then, after setting the IP address acquired by the address decision unit 33 in the network interface 11 (step 206), the server connection unit 36 transmits a connection request to the server 18 which can be identified from the server connection information sent from the connection request receiving unit 31 (step 207). The procedure of establishing a connection between the server 18 and the SSO server 30 follows a predetermined protocol, and in this exemplary embodiment, follows the connection establishing procedure of TCP. Here, if a connection fails to be established (N at step 208), the SSO server 30 notifies the client 20, which sent the connection request, of a connection error with the server 18 (step 214).

If a connection is successfully established (Y at step 208), the server connection unit 36 sends an authentication request to the connected server 18 (step 209). Authentication information that is sent being contained in this authentication request is authentication information for the SSO server 30 acquired by the authentication information acquiring unit 32.

If the authentication fails (N at step 210), the communication controller 34 disconnects the connection with the server 18, and also deletes the IP address set at step 206 from the network interface 11 (step 215). Then, the SSO server 30 notifies the client 20 which sent the connection request of an authentication error with the server 18 (step 214).

A client ID can be set in the address pool when the address decision unit 33 has decided the use of the IP address or when authentication has succeeded and a session has been established. The timing for setting a client ID needs to be determined in consideration of occurrence of such errors described above. At step 215, it is necessary to cancel matters that have been set since step 205 due to the occurrence of the error to return to the initial state. When a client ID should be set in the address pool essentially depends on program design including error handling and the like. In this exemplary embodiment, a client ID is set in the address pool after the establishment of a session is confirmed. Accordingly, the server connection unit 36 sets the client ID of the client 20 which sent a connection request associating it with an IP address which has been decided for use at the point when a user has been authenticated by the server 18.

When the user is authenticated by the server (Y at step 210), the session interruption unit 37 starts session interruption processing. Specifically, the session interruption unit 37 first acquires information on the established session (step 211). The session information acquired here includes TCP information, the IP address being used in the session with the server 18, a port number, a session identifier, and so forth. Then, the session interruption unit 37 performs processing for disabling the IP address by deleting the set IP address from the network interface 11 (step 212). Thereafter, the session information transmission unit 35 transmits the session information acquired by the session interruption unit 37 to the client 20 which is the sender of the connection request (step 213).

At this point in time, because the IP address has been deleted from the network interface 11 of the SSO server 30, the SSO server 30 is unable to communicate with the server 18, namely, it is in a state where a session is interrupted. Meanwhile, the server 18 is maintaining the session established with the SSO server 30.

While the client 20 has been waiting for receipt of session information after transmitting a connection request, when the session information receiving unit 22 receives session information sent from the SSO server 30 in response to the transmitted connection request (Y at step 102), the server connection unit 24 sets a TCP session using TCP information and the like contained in the session information (step 103). What is especially important is that an IP address contained in the session information is set in the network interface 11 of the client 20. On the other hand, if session information cannot be received at step 102, it can be due to receipt of an error notification or a timeout in which nothing can be received. In this case (N at step 102), the client 20 performs predetermined connection error handling, such as notification to the user through a message shown on the display 8, log recording, and the like (step 106).

The session setting processing performed at step 103 is setting processing performed for causing the client 20 to take over and use the session established on the SSO server 30. Regarding the SSO server 30 and the client 20 which communicate with the server 18 as a set, this processing can also be considered as environment setting for having the client 20 resume the session interrupted by the SSO server 30.

It is also possible that a port number notified by the SSO server 30 is already used by the client 20. To prevent this, a port number for use may be decided in conjunction with the server 30, e.g., the client 20 specifies a port number to be used or provides a list of available port numbers (i.e., notifies candidate port numbers for use), at the time of a connection request.

Through the foregoing setting processing, a session with the server 18 is set on the client 20 using exactly the same settings as the session that was established between the server 18 and the SSO server 30.

It is possible that a network device which internally stores and manages IP addresses of other network devices on the same link is connected to the LAN 12. In such a case, even if setting processing inside the client 20 is completed, network devices on the same link other than the client 20 and the SSO server 30 continue to recognize the IP address as the IP address of the SSO server 30 if nothing is done. Thus, the server connection unit 24 transmits a Gratuitous ARP packet to notify the other network devices that the IP address is now the IP address of the client 20 (step 104). Describing this processing more specifically, the client 20 transmits to the LAN 12 an inquiry about the holder of the IP address which the client 20 has taken over. This inquiry will be answered by the client 20 itself, i.e., the holder. That is, the client 20 sends a reply to the inquiry onto the LAN 12.

Although this exemplary embodiment illustrates a computer, generally a PC, as the client 20 that utilizes a service provided by the server 18, an image forming device, a network printer, a network scanner and the like which represent the other network devices mentioned above can serve as the client 20 as well.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A single sign-on system, comprising:
service provision servers that provide services;
a client that utilizes a service provided by the service provision servers; and
a single sign-on server that realizes single sign-on, wherein
the single sign-on server comprises:
a receiving unit that receives a server connection request transmitted from the client;
an establishing unit that transmits, to a service provision server identified from the received server connection request, an authentication request that contains at least an address for use in communication with the service provision server and authentication information of the single sign-on server, undergoes user authentication, and establishes a session with the service provision server;
a disabling unit that performs disabling processing of the address which is being used in communication with the service provision server; and
an information transmission unit that transmits session information on the session established with the service provision server, the session information containing at least the address, to the client that transmits the server connection request, and wherein
the client comprises:
a request transmission unit that transmits to the single sign-on server a server connection request for the service provision server;
a session information receiving unit that receives session information transmitted from the single sign-on server in response to the transmitted server connection request; and
a communication unit that uses an address contained in the session information received by the information receiving unit for communication with the service provision server, and takes over the session that has been established by the single sign-on server with the service provision server to communicate with the service provision server.

2. A computer readable medium storing a program causing a computer to execute a process for realizing single sign-on, the process comprising:
transmitting a server connection request for the service provision server to a single sign-on server that realizes single sign-on;
receiving session information transmitted from the single sign-on server in response to the transmitted server connection request; and
using an address contained in the received session information for communication with the service provision server, and taking over a session that has been established by the single sign-on server with the service provision server to communicate with the service provision server.

3. A computer readable medium storing a program causing a computer to execute a process for realizing single sign-on, the process comprising:
receiving a server connection request for a service provision server that provides a service from an information terminal device that utilizes the service provided by the service provision server;
transmitting, to the service provision server identified from the received server connection request, an authentication request that contains at least an address for use in communication with the service provision server and authentication information of the computer to thereby establish a session with the service provision server;
performing disabling processing of the address which is being used in communication with the service provision server; and
transmitting session information on the session established with the service provision server, the session information containing at least the address, to the information terminal device which transmits the server connection request.

4. The computer readable medium according to claim 3, wherein the process further comprises:
selecting an unused address for use in communication with a service provision server that is identified from a server connection request from among addresses that are prepared in advance for use in communication with the service provision servers.

5. The computer readable medium according to claim 3, wherein the process further comprises:
selecting an unused address for use in communication with a service provision server identified from a server connection request from among arbitrary addresses that are available on the same link.

6. An information terminal device, comprising:
a request transmission unit that transmits, to a single sign-on server that realizes single sign-on, a server connection request for a service provision server that provides a service; and
a communication unit that uses for communication with the service provision server an address contained in session information which is transmitted from the single sign-on server in response to the transmitted server connection request to thereby take over a session that has been established by the single sign-on server with the service provision server, and communicates with the service provision server.

7. A single sign-on server, comprising:
a receiving unit that receives a server connection request from a client for a service provision server that provides a service;
an establishing unit that transmits, to a service provision server identified from the received server connection request, an authentication request that contains at least an address for use in communication with the service provision server and authentication information set for the single sign-on server, undergoes user authentication, and establishes a session with the service provision server;
a disabling unit that performs disabling processing of the address which is being used in communication with the service provision server; and
an information transmission unit that transmits session information on the session established with the service provision server, the session information containing at least the address, to the client that transmits the server connection request.

8. A method for realizing single sign-on, the method comprising:
transmitting a server connection request for the service provision server to a single sign-on server that realizes single sign-on;
receiving session information transmitted from the single sign-on server in response to the transmitted server connection request; and
using an address contained in the received session information for communication with the service provision server, and taking over a session that has been established by the single sign-on server with the service provision server to communicate with the service provision server.

9. A method for realizing single sign-on, the method comprising:
receiving a server connection request for a service provision server that provides a service from an information terminal device that utilizes the service provided by the service provision server;
transmitting, to the service provision server identified from the received server connection request, an authentication request that contains at least an address for use in communication with the service provision server and authentication information of the computer to thereby establish a session with the service provision server;
performing disabling processing of the address which is being used in communication with the service provision server; and
transmitting session information on the session established with the service provision server, the session information containing at least the address, to the information terminal device which transmits the server connection request.

10. A computer data signal embodied in a carrier wave for enabling a computer to perform a process for realizing single sign-on, the process comprising:
transmitting a server connection request for the service provision server to a single sign-on server that realizes single sign-on;
receiving session information transmitted from the single sign-on server in response to the transmitted server connection request; and
using an address contained in the received session information for communication with the service provision server, and taking over a session that has been established by the single sign-on server with the service provision server to communicate with the service provision server.

11. A computer data signal embodied in a carrier wave for enabling a computer to perform a process for realizing single sign-on, the process comprising:
receiving a server connection request for a service provision server that provides a service from an information terminal device that utilizes the service provided by the service provision server;
transmitting, to the service provision server identified from the received server connection request, an authentication request that contains at least an address for use in communication with the service provision server and authentication information of the computer to thereby establish a session with the service provision server;
performing disabling processing of the address which is being used in communication with the service provision server; and
transmitting session information on the session established with the service provision server, the session information containing at least the address, to the information terminal device which transmits the server connection request.
